(19) United States
(12) Patent Application Publication
(10) Pub. No.: US 2008/0107071 A1
(43) Pub. Date: May 8, 2008

(54) Channel selection in a wireless network

(76) Inventors: Andrey L. Tsigler, Hillsborough, NC (US); Shashidhara Seetharamaiah Ganesha Rao, Bangalore (IN)

Correspondence Address: Brake Hughes Bellermann LLP;c/o Intellevate, P.O. Box 52050, Minneapolis, MN, 55402, US

(21) Appl. No.: 11/593,700

(22) Filed: Nov. 6, 2006

(51) Int. Cl. H04Q 7/00

(52) U.S. Cl. 370/329

(57) ABSTRACT

In order to achieve improved performance for users on a wireless network, it is desirable to reduce interference between wireless access points (APs or WAPs) by selectively assigning different channels to the radios of the APs in a-neighborhood. This may be performed by process whereby a central controller automatically assigns channels to one or more APs managed by that controller in accordance with a channel selection algorithm that considers received signal strength indication (RSSI) and transmit (Tx) or receive (Rx) error rates on channels of the radios. The algorithm also takes into account any stand-alone APs in the network (i.e., not connected to the network) and assigns the channels to managed APs in such a way as to avoid interference with the stand-alone APs.

### FIELD OF THE INVENTION

This invention relates generally to wireless networks and more particularly to channel selection in an IEEE 802.11 wireless network operating under one or more variants of the IEEE 802.11 wireless standard and having a one or more wireless access points (APs).

### BACKGROUND

Wireless networks are proliferating at least in part because of the reduced infrastructure as well as the ease of connectability and convenience to users. In many instances, entire offices are becoming wireless or at least wirelessly-enabled as organizations develop wireless local area networks (WLANs) generally based on the IEEE 802.11 wireless standard, which is incorporated herein in its entirety and made a part hereof.

IEEE 802.11 denotes a set of WLAN standards developed by working group 11 of the IEEE LAN/MAN Standards Committee (IEEE 802). The term 802.11x is also used to denote this set of standards and is not to be mistaken for any one of its elements. There is no single 802.11x standard. The 802.11 family currently includes six over-the-air modulation techniques that all use the same protocol. The most popular (and prolific) techniques are those defined by the b, a, and g amendments to the original standard. Other standards in the family (c-f, h, j) are service enhancements and extensions or corrections to previous specifications. 802.11b was the first widely accepted wireless networking standard, followed (somewhat counterintuitively) by 802.11a and 802.11g. 802.11b and 802.11g standards use the 2.4 gigahertz (GHz) band, operating (in the USA) under Part 15 of the FCC Rules and Regulations. Because of this choice of frequency band, 802.11b and 802.11g equipment can incur interference from microwave ovens, cordless telephones, Bluetooth devices, and other appliances using this same band. The 802.11a standard uses the 5 GHz band, and is therefore not affected by products operating on the 2.4 GHz band.

802.11b and 802.11g divide the 2.4 GHz spectrum into 14 overlapping, staggered channels whose center frequencies are 5 megahertz (MHz) apart. The 802.11b and 802.11g standards do not specify the width of a channel; rather, they specify the center frequency of the channel and a spectral mask for that channel. The spectral mask for 802.11b requires that the signal be attenuated by at least 30 dB from its peak energy at ±11 MHz from the center frequency, and attenuated by at least 50 dB from its peak energy at ±22 MHz from the center frequency. Since the spectral mask only defines power output restrictions up to ±22 MHz from the center frequency, it is often assumed that the energy of the channel extends no further than these limits. In reality, if the transmitter is sufficiently powerful, the signal can be quite strong even beyond the ±22 MHz point. Therefore, it is somewhat of a misconception that channels 1, 6, and 11 do not overlap. It is more correct to say that, given the separation between channels 1, 6, and 11, the signal on any channel should be sufficiently attenuated to minimally interfere with a transmitter on any other channel. However, this is not universally true; for example, a powerful transmitter on channel 1 can easily overwhelm a weaker transmitter on channel 6.

Although the statement that channels 1, 6, and 11 are “non-overlapping” is incomplete, the 1-6-11 guideline has merit. If transmitters are closer together than channels 1, 6, and 11 (for example, 1, 4, 7, and 10), overlap between the channels will probably cause unacceptable degradation of signal quality and throughput. The channels that are available for use in a particular country differ according to the regulations of that country. In the United States, for example, FCC regulations only allow channels 1 through 11 to be used. In Europe channels 1-13 are licensed for 802.11b operation but only allow lower transmitted power (only 100 mW) to reduce the interference with other ISM band users.

In order to provide wireless connectivity to users in a large space, such as an office building, network administrators generally connect one or more 802.11 APs to their wired networks. These access points are commonly managed via a central controller. However, because of the environment in which a wireless network may operate in regard to interference and because of the overlapping channel configuration of many of the AP channels, the APs may experience interference on one or more of their channels that may affect the performance of the wireless network.

### SUMMARY OF THE INVENTION

A system and/or method for channel selection in a wireless network, substantially as shown in and/or described in connection with at least one of the figures, as set forth more completely in the claims.

### BRIEF DESCRIPTION OF THE DRAWINGS

FIG. 1A is an exemplary computing device is illustrated that can be used to practice aspects of the preferred embodiment.

FIG. 1B is an alternative embodiment of a processing system of that shown in FIG. 1A.

FIG. 2 is an illustration of a wireless communications system (e.g., WLAN) that may be known in the art and may be used to practice various embodiments according to the present invention.

FIG. 3 is a flowchart that describes the process of channel selection according to an example embodiment.

FIG. 4 is an exemplary RSSI matrix for an exemplary wireless network.

FIG. 5 is an illustration of an exemplary neighborhood of radios that may be used to practice various aspects according to the present invention.

FIGS. 6A, 6B and 6C are exemplary matrices showing RSSI values for the channels 1,6 and 11 for radios in the exemplary neighborhood shown in FIG. 5.

FIGS. 6D, 6E and 6F are exemplary bitmap matrices for the channels 1,6 and 11, which correspond to the RSSI matrices of FIGS. 6D, 6E and 6F, respectively.

FIG. 7 is an illustration of the exemplary neighborhood of radios shown in FIG. 5 subsequent to execution of the channel assignment algorithm according to an example embodiment.

FIG. 8 is an illustration of a flowchart for a channel selection algorithm according to an example embodiment.

### DESCRIPTION OF THE PREFERRED EMBODIMENTS

The present invention may be understood more readily by reference to the following detailed description of preferred embodiments of the invention and the examples and the figures included therewith.

As used in the specification and the appended claims, the singular forms “a,” “an” and “the” include plural referents unless the context clearly dictates otherwise. For example, reference to “a” or “an” RSSI value may include two or more RSSI values and references to “a” transmit error rate or “a” receive error rate may actually comprise more than one transmit and/or receive error rate.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it may be understood that the particular value forms another embodiment. It may be further understood that the endpoints of each of the ranges may be significant both in relation to the other endpoint, and independently of the other endpoint.

In this specification and in the claims which follow, reference will be made to a number of terms which shall be defined to have the following meanings: “Optional” or “optionally” means that the subsequently described event or circumstance may or may not occur, and that the description includes instances where said event or circumstance occurs and instances where it does not.

Reference will now be made in detail to the present embodiments according to the invention, examples of which are illustrated in the accompanying drawings. Wherever possible, the same reference numbers are used throughout the drawings to refer to the same or like parts.

As will be appreciated by one skilled in the art, the preferred embodiment may be implemented as a method, a data processing system, or a computer program product. Accordingly, the preferred embodiment may take the form of an entirely hardware embodiment, an entirely software embodiment, or an embodiment combining software and hardware aspects. Furthermore, implementations of the preferred embodiment may take the form of a computer program product on a computer-readable storage medium having computer-readable program instructions (e.g., computer software) embodied in the storage medium. More particularly, implementations of the preferred embodiments may take the form of web-implemented computer software. Any suitable computer-readable storage medium may be utilized including hard disks, CD-ROMs, optical storage-devices, or magnetic storage devices.

The preferred embodiments according to the present invention are described below with reference to block diagrams and flowchart illustrations of methods, apparatuses (e.g., systems) and computer program products according to an embodiment of the invention. It may be understood that each block of the block diagrams and flowchart illustrations, and combinations of blocks in the block diagrams and flowchart illustrations, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory may produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It may also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

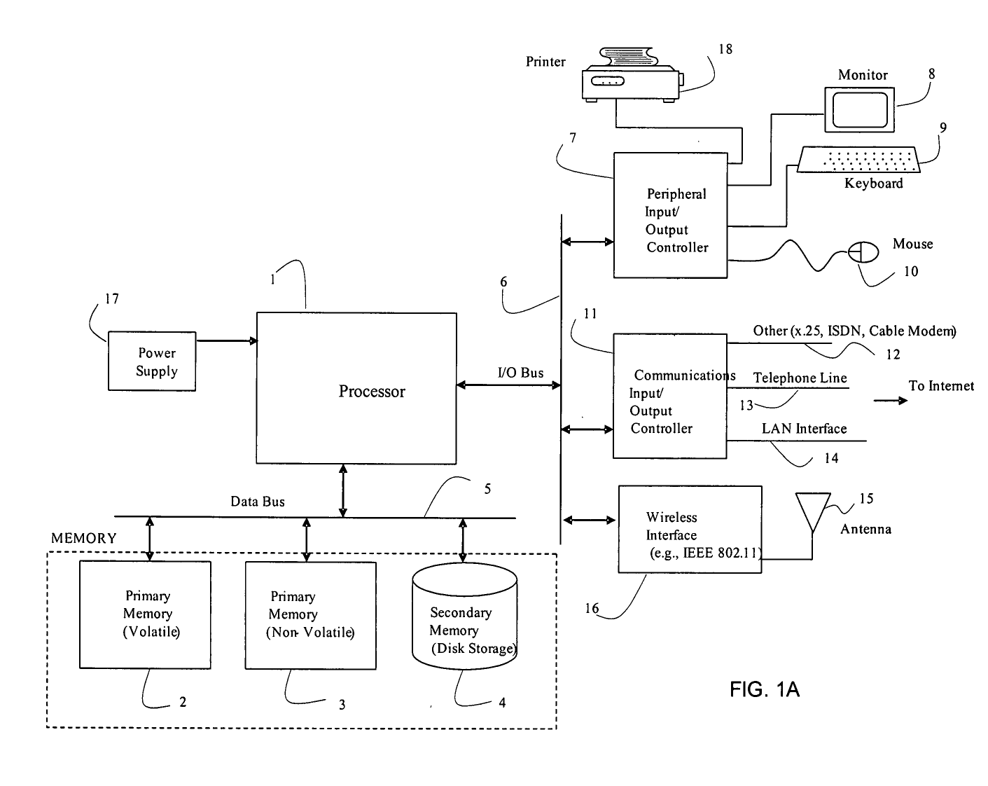

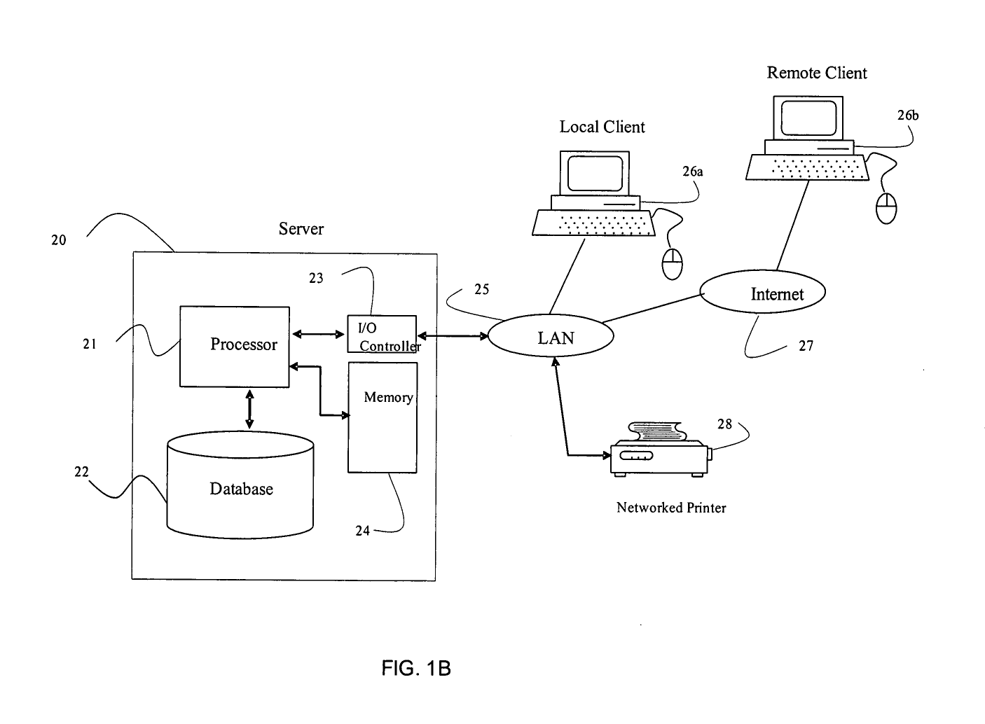

In the preferred embodiments referenced herein, a “computer,” “computing device,” “controller,” or “server” may be referenced. Such computer may be, for example, a mainframe, desktop, notebook or laptop, a hand held device such as a data acquisition and storage device, or embodiments it may be a processing device embodied within another apparatus such as, for example, a set top box for a television system or a wireless telephone. In some instances the computer may be a “dumb” terminal used to access data or processors over a network. Turning to FIG. 1A, one embodiment of a computing device is illustrated that can be used to practice aspects of the preferred embodiment. In FIG. 1A, a processor 1, such as a microprocessor, is used to execute software instructions for carrying out the defined steps. The processor 1 receives power from a power supply 17 that also provides power to the other components as necessary. The processor 1 communicates using a data bus 5 that may be 16 or 32 bits wide (i.e., in parallel), for example. The data bus 5 is used to convey data and program instructions, typically, between the processor 1 and memory. In the present embodiment, memory may include primary memory 2 such as RAM or other forms which retain the contents only during operation, or non-volatile memory 3, such as ROM, EPROM, EEPROM, FLASH, or other types of memory that retain the memory contents. The memory may include secondary memory 4, such as disk storage, that stores large amounts of data. In some embodiments, the secondary memory 4 may communicate with the processor 1 using an I/O bus 6 instead or a dedicated bus (not shown). The secondary memory 4 may include a floppy disk, hard disk, compact disk, DVD, or any other type of mass storage type known to those skilled in the computer arts.

The processor 1 may also communicate with various peripherals or external devices using the I/O bus 6. In the present embodiment, a peripheral I/O controller 7 may be used to provide standard interfaces, such as RS-232, RS422, DIN, USB, or other interfaces as appropriate to interface various input/output devices. Typical input/output devices include local printers 18, a monitor 8, a keyboard 9, and a mouse 10 or other pointing device(s) (e.g., rollerball, trackpad, joystick, etc.).

The processor 1 may also communicate using a communications I/O controller 11 with external communication networks, and may use a variety of interfaces such as data communication oriented protocols 12 such as X.25, ISDN, DSL, cable modems, etc. The communications controller 11 may also incorporate a modem (not shown) for interfacing and communicating with a standard telephone line 13. Finally, the communications I/O controller 11 may incorporate an Ethernet interface 14 for communicating over a LAN. Any of these interfaces (e.g., other 12, telephone line 13, LAN interface 14) may be used to access a wide area network such as the Internet, intranets, LANs, or other data communication facilities.

The processor 1 may communicate with a wireless interface 16 that may be operatively connected to an antenna 15 for communicating wirelessly with another device, using for example, one of the IEEE 802.11 protocols, 802.15.4 protocol, or a standard 3G wireless telecommunications protocols, such as CDMA2000 1x EV-DO, GPRS, W-CDMA, or other protocol.

An alternative embodiment of a processing system that may be used is shown in FIG. 1B. In this embodiment, a distributed communication and processing architecture is shown involving a server 20 communicating with either a local client computer 26a or a remote client computer 26b. The server 20 typically comprises a processor 21 that communicates with a database 22, which can be viewed as a form of secondary memory, and/or primary memory 24. The processor 21 may also communicate with external devices using an I/O controller 23 that may interface with a LAN 25. The LAN 25 may provide local connectivity to a networked printer 28 and the local client computer 26a. Communication with remote devices may be accomplished by routing data from the LAN 25 over a communications facility to a wide area network 27, such as the Internet. A remote client computer 26b may execute a web browser, so that the remote client 26b may interact with the server 20 as required by transmitted data through the wide area network 27, over the LAN 25, and to the server 20.

Those skilled in the art of data networking will realize that many other alternatives and architectures are possible and can be used to practice the preferred embodiments. The embodiments illustrated in FIGS. 1A and 1B can be modified in different ways and be within the scope of the present invention as claimed.

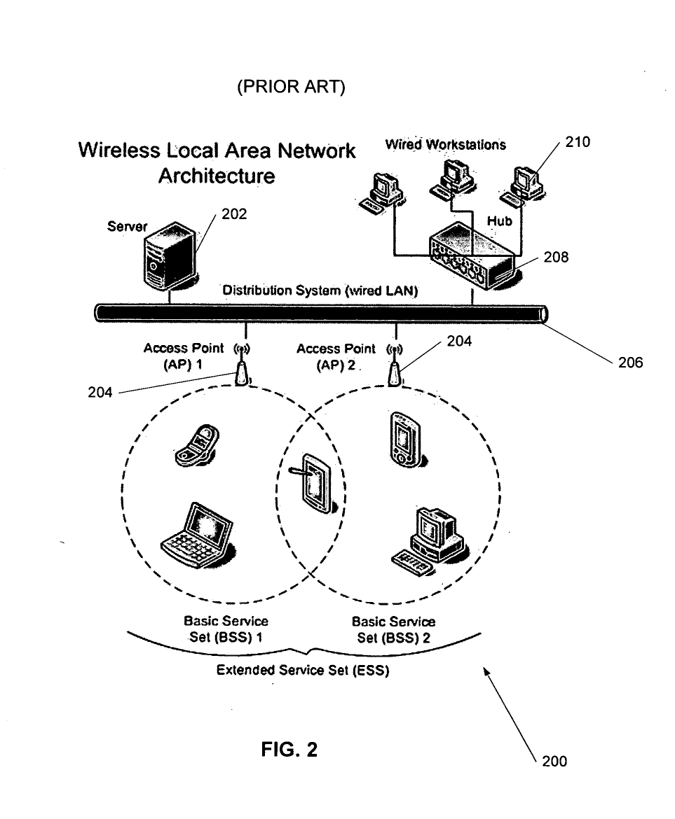

In order to provide wireless connectivity to users in a space such as, for example, an office building, network administrators may connect many IEEE 802.11 access points (APs) to their wired networks. FIG. 2 illustrates an exemplary wireless network 200 including a server 202, that may in some instances act as a central controller, one or more access points 204 (e.g, (AP) 1 and (AP) 2)), and a distribution system 206, which in the exemplary system of FIG. 2 is a wired LAN. The system of FIG. 2 may also include one or more hubs 208 and one or more additional workstations 210.

Access points 204 are generally comprised of one or more radio transceivers, that may be configured to operate on one of a group of defined channels and to switch between channels. Access points 204 that may be utilized in one or more embodiments according to the present invention include, for example, NETGEAR WAG302_TM access points as manufactured by NETGEAR Inc., of Santa Clara, Calif. However, it may be appreciated that other wireless access points may be employed such that the APs 204 include one or more radios (e.g., radio transceivers) that may operate on a channel for the 802.11b/g or 802.11a band. In the exemplary embodiments described herein, it is generally assumed that each AP 204 has one radio, and the terms “transceiver,” “radio” and “AP” may be used interchangeably throughout this document, though it is to be appreciated that APs 204 having more than one radio are within the scope of the present invention. The APs 204 described herein may measure RSSI on the operational channel as well as other channels in the 802.11 operational band. It is expected that each radio periodically moves away from the operational channel for a short time and monitors other channels in the operating band. The process of detecting other devices on the network and measuring their signal strength is generally referred to as an “RF Scan.” Furthermore, APs utilized in embodiments may be configured to measure the packet transmit/receive rates and transmit/receive errors.

Access points 204 are commonly managed via a central controller 202. The central controller 202 may include a wireless switch or a management station configured to obtain RSSI readings and statistics from the APs 204 and set the channel configuration of the access points 204.

In order to achieve improved performance for users on the wireless network 200 it may be desirable to reduce interference between the access points 204 by selectively assigning different channels to the radios of the APs 204. This may be performed by processes whereby the central controller 202 automatically assigns channels to one or more APs 204 managed by the central controller 202. The algorithm also takes into account any stand-alone APs in the network (e.g., not connected to the network 200) and assigns the channels to managed APs 204 in such a way as to avoid interference with the stand-alone APs.

In one embodiment according to the present invention, the process includes having the APs 204 in the network 200 “listen” to the IEEE 802.11 beacon frames from other managed and/or stand-alone APs. An AP 204 may listen for beacons on its operational channel, which is the channel on which the AP forwards user traffic, as well as other channels in the 802.11 band. The other channels are monitored for a brief period of time in order to minimize impact on data throughput. The beacon frames identify the AP 204 from which they are transmitted. By listening for beacon frames on its operational channel as well as the other 802.11 channels, an AP 204 can determine the interference (e.g., RSSI) it is receiving from neighboring APs, including the APs causing the RSSI.

In another embodiment according to the present invention, an AP 204 may monitor the error rates for transmitted and received packets in addition to RSSI, whereby a transmit error rate and a receive error rate, respectively, may be determined. These error rates and the information from the received beacon frames are communicated by the AP 204 to the central controller 202, which may use the information as input to a channel selection algorithm. Included in the information transmitted to the central controller 202 may be the identity of the transmitter of the frame, referred to as basic server set identifier (BSSID) in the 802.11 protocol, and the receive signal strength indication (RSSI) for the frame.

The channel selection algorithm may run periodically on the central controller 202. Generally, the time period between executions of the channel selection algorithm may be fairly lengthy, for example, on the order of hours, in order to accumulate enough signal strength and error rate data to make a good decision on whether any channel change is required. If the central controller 202 detects that an AP 204 can hear a signal with high RSSI from another AP on the same operational channel, then the central controller 202 may consider the AP 204 as a candidate for a channel change. The AP 204 may also be considered a candidate if the transmit (Tx) and receive (Rx) error rates are high on the AP 204, even if no strong signal is received from any other APs. The channel selection algorithm may keep a history of APs 204 that it changed each time the algorithm runs. The history may be kept for several channel selection algorithm iterations, and the algorithm does not attempt to modify the channel on APs 204 included in the history.

The APs 204 in the network 200 may be grouped as “neighborhoods” (N), where a neighborhood is a group of APs 204 that can see each other. When the channel selection algorithm executes, it may change the channel of an AP 204 in a “neighborhood.” Parameters such as a threshold for the RSSI value for deciding to change the channel, the Tx and Rx error rates, the frequency of channel selection algorithm runs, and the number of entries saved in the history may be either configurable or tuned for specific hardware and network needs. While generally directed toward wireless networks operating on the IEEE 802.11 standard, it may be appreciated that the channel selection algorithm may be implemented by any system that relies on central control of managed APs and is able to gather the required information from the APs and change channels on the APs.

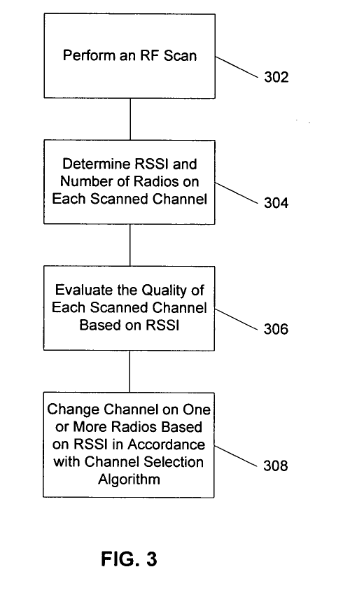

FIG. 3 is a flowchart that describes the process of channel selection in an embodiment according to the present invention. The IEEE 802.11b and 802.11g available frequency spectrum is generally divided into about 11 channels (depending on the deployed country), in which some channels are overlapping. Of these 11 channels, only 3 are non-overlapping, or have their center frequencies separated far enough to minimize interference, which are generally identified as channels 1, 6 and 11. The goal of the described channel selection process is to efficiently assign non-overlapping channels to the interfering APs.

At step 302, the radio of an AP in a wireless network periodically performs an RF scan on the AP's operational channel and other channels on which the AP may operate. Once the RF scan is complete, at step 304 the AP sends the following information to the controller: RSSI from the “neighbor radios” operating in the channels scanned by the AP. Here the “neighbor radios” include the radios of the stand-alone APs (e.g., those APs not managed by the central controller) along with the radios of the managed APs. The radios operating on overlapping channels (e.g., neighbors operating on channel 1 include the radios operating on channel 2 and 3; neighbors operating on channel 6 include the radios operating on channel 4, 5, 7, 8; neighbors operating on channel 11 include the radios operating on channels 9, 10, 12, 13, etc.) may also be considered in the RF scan. The AP may also send the total number of radios operating in each of those scanned channels to the central controller.

At step 306 the channel selection algorithm executing on a processor of the controller evaluates the quality of the channel for each radio on which it is operating and also the quality of the other available channels, using the received signal strength indication (RSSI) from the neighbor radios in a given channel. The channel selection algorithm uses the RSSI to evaluate for possible channel changes. When the algorithm runs it may update the list of radios that are good candidates for changing their operating channel. The list may include the radios which have worst current channel quality and good alternate channels.

At step 308, the central controller may signal to one or more of the APs of a wireless network to change channels based upon the evaluation of the RSSI that occurred in step 306. Furthermore, in one embodiment, the channel selection algorithm avoids a situation where channels are changed back and forth for every channel change period. This may be achieved by keeping several previous channel allocation plans and not changing the channel to any channel that was already used in recent channel changes. It may also be appreciated that in one embodiment, an operator can see the list of candidates for changing the channel using a command. After evaluating the good candidates, the central controller may apply the new channel to all the members of the candidate list either at the request of the administrator or periodically.

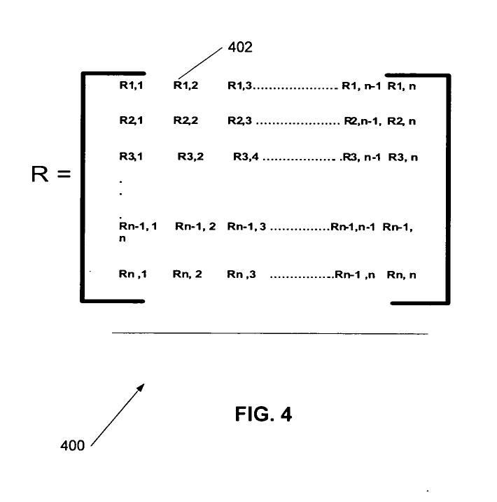

The following illustration is for an exemplary wireless network comprised of multiple APs and at least one central controller such as the one shown in FIG. 2. The calculations and parameters in this section are exemplary only and should not be considered as limiting. FIG. 4 is an exemplary RSSI matrix 400 for the exemplary wireless network. RSSI received from each radio with respect to other radios in the network is represented in a matrix notation. Where, for example, R_{1,2} 402 is the RSSI received from Radio₂ at Radio₁. The matrix shown in FIG. 4 is a N×N matrix which may have some values equal to 0 indicating that not all APs, including their radios, in the network are seen by all other APs, hence their corresponding RSSI entry may be 0. An RSSI value may be provided on a 1-100 scale such that when the RSSI value is closer to 0 it indicates that the interference from that radio at the given radio is low, and a value closer to 100 indicates that the interference is high.

The implementation of an RSSI matrix 400 such as that shown in FIG. 4 can be done using a two dimensional array. Each entry, for example “(x,y)”, where x represents the row number, and y represents the column number, in the array would indicate the RSSI from ‘y’ at ‘x’. However, such a representation may consume more bytes of memory when the size N becomes bigger. In order to minimize memory usage an alternative approach can be chosen in one embodiment according to the present invention, in which instead of having RSSI value itself stored in the matrix, a bit can be set if the given RSSI value is greater than an established “channel is bad” threshold (RT). When carrying out the calculation in the channel selection algorithm, this bitmap will be checked, and if the bit is set than the corresponding RSSI value should be obtained from the operational data structures (e.g., the RSSI matrix 400). This bitmap may be constructed every time a new iteration of the channel adjustment algorithm is started. Such an RSSI bitmap may be maintained for each channel of operation in the system. The usage of bitmap notation helps in maintaining the different set of channel plans at different point in time as well as makes the calculation easier.

The transmission and reception error rates of a radio indicate how well the current operating channel is for communicating with the associated clients. When preparing the candidate list for the next possible channel change, if the RSSI is acceptable in the operating channel (e.g., very little interference in the operating channel), then transmission and/or reception error rate can be used as used to determine whether to change channels. Alternatively, the RSSI value and the receive and/or transmit error rates may all be used as factors to help determine whether to change channels. If the transmission error rate and reception error rates are greater than a pre-established allowed limit, then the other available channels may be tried, provided they have same or better RSSI values. The possible reasons for having higher transmission and reception error rates may include RF interference due to the presence of another RF device (e.g., microwave oven) transmitting in the same frequency band or may include the presence of a hidden node (non-managed AP). The transmission and reception error rates maybe calculated as shown below:

Transmission error rate=Tx Error to Tx Success ratio=Number of Tx error packets/number of Tx successful packets

Reception error rate=Rx Error to Rx Success ratio=number of Rx error packets/number of Rx successful packets

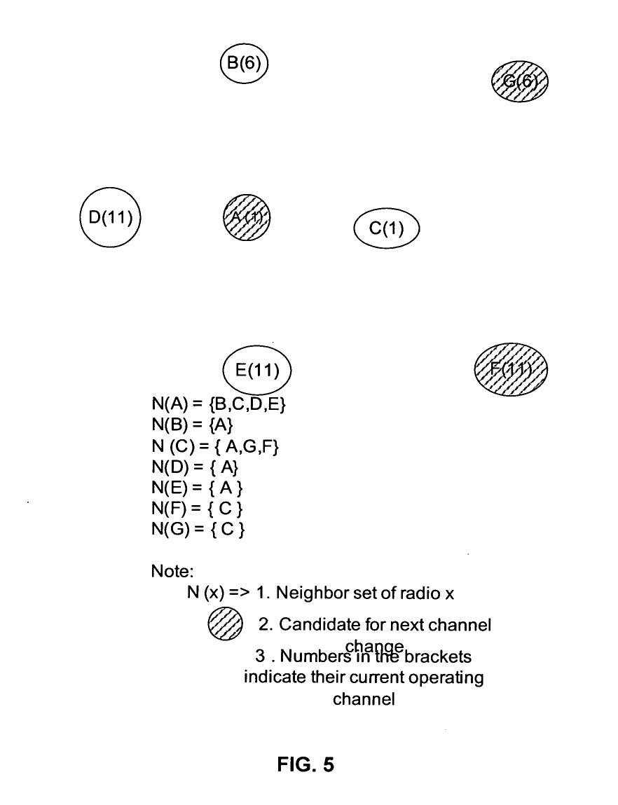

While preparing the possible candidate list for the next possible change, one or more restrictions may be considered by the channel selection algorithm. These restrictions may include, for example, that the operating channel of only one radio in a neighborhood of APs should be changed. Consider, for example, the neighborhood of radios as shown in FIG. 5. Here radios A, G and F may be selected to be considered for the next possible channel change. Another similar set would be {By D, E} or {By C, E} etc. All the above possible candidates for channel change will not be able to “see” (e.g., overlap) each other on any of the channels (e.g., 1, 6 or 11).

Referring to FIG. 5, an exemplary channel selection algorithm may be executed. While the channel selection algorithm as described in the following example may be applicable for 802.11b and 802.11g networks, it may be equally applicable to 802.11a networks with the exception that 802.11a does not have overlapping channels. First, let U=the set of all the radios of controller-managed APs and the radios of stand-alone APs in the network; N=the total number of radios of controller-managed APs and that of stand-alone APs; C=the total number of non-overlapping channels; R_{T}=the RSSI threshold, whereby a value observed greater than the RSSI threshold is considered for a possible channel change; Q=the set of radios considered for next possible channel change; M=is the number of radios considered for next possible channel change; Q_{PREV}=the set of radios which are previously considered for channel change; R1, R6, R1l=the RSSI matrices for channels 1, 6 and 11, respectively; Nₓ=the interfering neighbor set of radios for radio “X” (e.g., N_{A}=neighbor set of radio “A” (e.g., the neighbor radios for radio “A” which have RSSI value greater than R_{T})); Z=the set of radios which see RSSI values greater than R_{T} from neighbor radios in their current operating channel; L=the number of managed AP radios; and S=the set of all the stand-alone AP radios found in the network.

The process starts by determining U and N, where U is the set of controller-managed AP radios and total number of managed AP radios and stand-alone AP radios and N is the number of such radios. For example, in FIG. 5, U={A, B, C, D, E , F, G} and N=7. The total number of non overlapping channels (C) is three (channels 1, 6, and 11), so C=3. R_{T} is the RSSI threshold. An RSSI value observed greater this on an operating channel can cause that channel to be considered for a possible channel change. In this example R_{T} may be 30 (i.e., R_{T}=30). Q is the set of radios identified for the next possible channel change and in the exemplary neighborhood of FIG. 5 Q={ } (this set may be populated at the end of the algorithm). Q_{PREV} is the set of radios which were identified for the previous channel change and, as with Q, in the exemplary neighborhood of FIG. 5 Q_{PREV}={ } (as this set is empty since there is no previous record available).

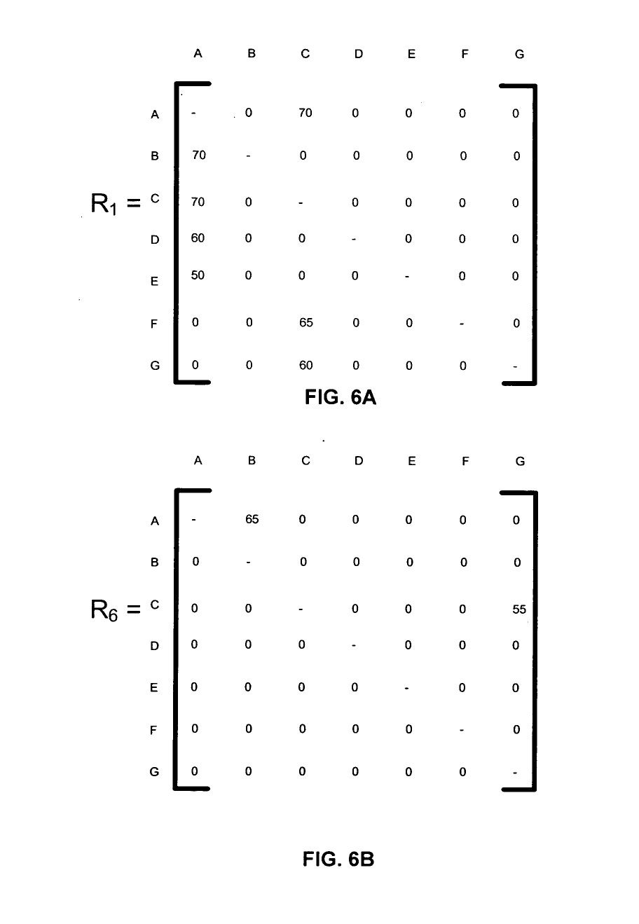

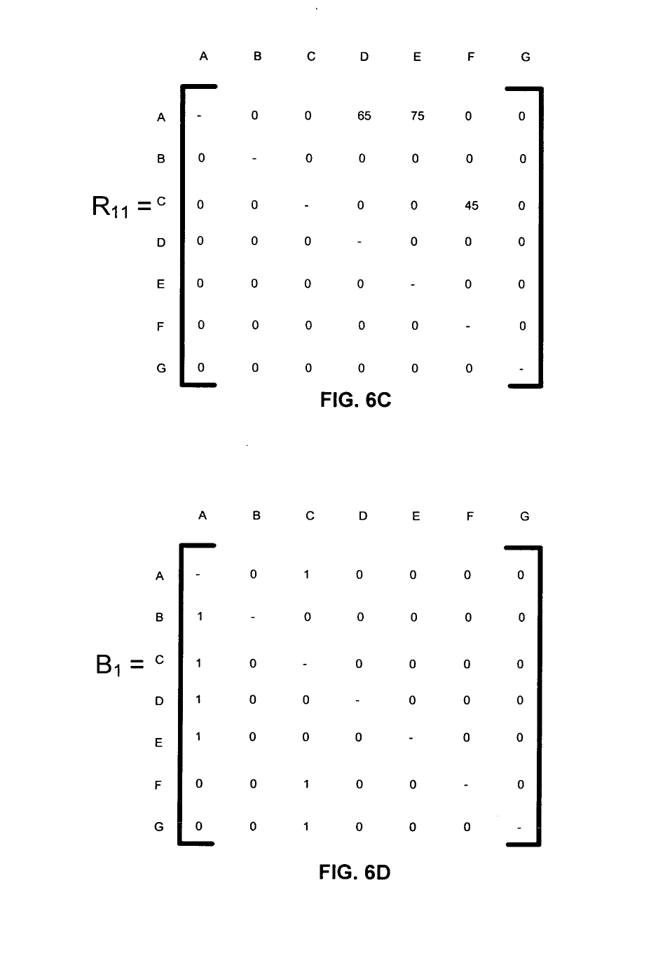

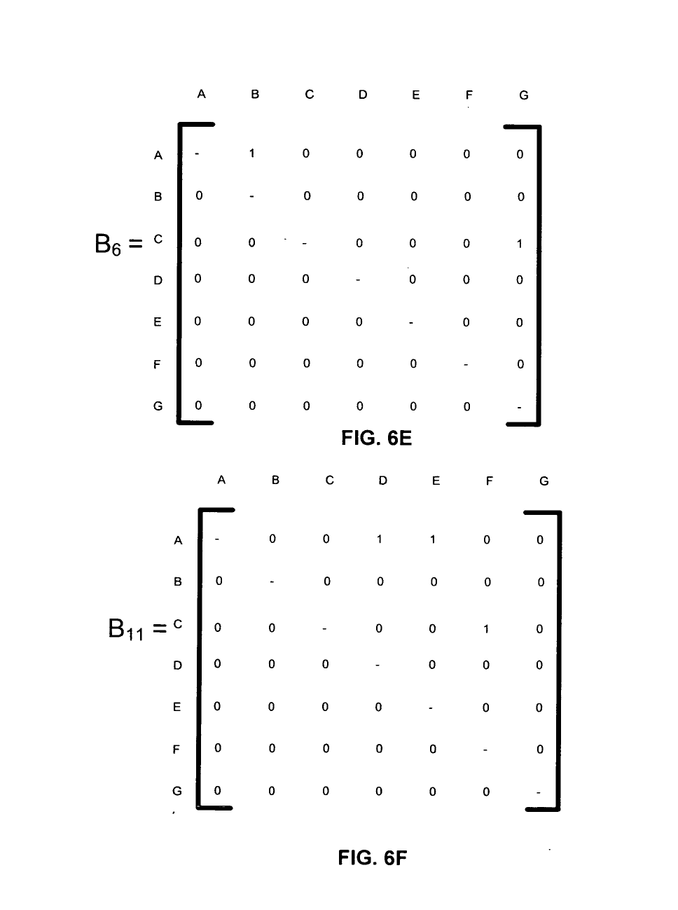

The process involves preparing an RSSI matrix for all of the three non-overlapping channels (1, 6, 11), and they are represented by matrices R₁, R₆ and R₁₁, where FIGS. 6A, 6B and 6C show the RSSI values for the channels 1, 6 and 11, respectively and FIGS. 6D, 6E and 6F show the corresponding RSSI bitmaps for the matrices R₁, R₆ and R₁₁, respectively. Neighbors operating on channel 1 include, for example, the radios operating on channels 2 and 3; neighbors operating on channel 6 include, for example, the radios operating on channels 4, 5, 7, 8; and neighbors operating on channel 11 include, for example, the radios operating on channels 9, 10, 12, and 13. The process further involves determining and preparing the interfering neighbor set for each radio using the RSSI bitmaps. If the RSSI bitmap has an entry for row X under column Y set to 1 (which indicates the RSSI is greater than R_{T}), then Y is considered to be the interfering neighbor of X, and there should be a non-zero entry for row X under column Y for each matrix R₁, R₆ and R₁₁. It also implies that the Radioₓ is able to see the neighbor Radio_{y} on all the non-overlapping channels. From the non-zero entries in the bitmap matrices (FIGS. 6D, 6E, and 6F), the radios that can be “seen” from other radios on the non-overlapping channels (1, 6, and 11) can be determined. For example, the bitmap matrices indicates that radio A “sees” RSSI from radios C, B, D and E on channels 1, 6 and 11 (i.e., N_{A}={C, B, D, E}). Similarly, and referencing FIGS. 6D, 6E, and 6F, it may be seen that N_{B}={A}; N_{C}={A,G,F}; N_{D}={A}; N_{E}={A}; N_{F}={C}; and N_{G}={C}.

Next, for a selected radio of a set of radios, a set of radios for example Z, is prepared whereby these radios have an RSSI value in the current operating channel for the selected radio that is greater than R_{T}. Let the size of this list be K, but note that K may be equal to N. For example, Z={A, C}. Candidates are then removed from Z if they have already been considered previously for a channel assignment (Z=Z−Q_{PREV}). For example, Z={A, C}−{ }; and Z={A, C} since there were no previously considered candidates for channel change, the set Z remains unchanged. The set Z is sorted in the descending order based on the RSSI values. In this example, after sorting, Z={A, C}, since A and C are neighbors and both see the same RSSI value (=70). It may not always be a true condition that neighbors see the same RSSI value because RSSI measurements are very sensitive and vary over small geographical changes. For each radio in the Z set, do the following until Z becomes an empty set (i.e., K=O): A loop is started (iterative), whereby {k=1 to K}, that encompasses the following steps: for Q=Q+Z(k), whereby Z(k) is added to Q (e.g., the first element in the Z set having the highest RSSI value is added to the Q set); next Z=Z−N{Z(k)}, whereby the neighbors of Z(k) are eliminated from Z; then Z(k) is eliminated from Z, Z=Z−Z(k); and the value of K is updated such that K=K−( number of neighbors of Z(k)+1), because Z(k) is also being removed, which ends the loop. As previously provided, the size of set Q=M. Here, Q={A} (hence M=1) and C gets eliminated since C is the neighbor of A.

An optional step in the process may be to determine transmit (Tx) and receive (Rx) error rates. This step may be optional if Q is a non-empty set and mandatory if Q is empty and channel selection is desired. The purpose of this step is to prepare a set based on Tx error rate factor which contains the radios excluding the candidates considered for channel change (e.g., members of Q) and the neighbors of the radios present in Q. This step may aid in determining which radios do not have an RSSI problem but may have problems with Tx rate, which may also influence a possible channel change. Depending on the size of the set Q, the next set of candidates for channel switching are identified, hence the process takes two different paths based on the size of Q.

First, if Q is empty then let P=U−S; where S is all the unmanaged (rogue) radios and P is the set of all radios with the radios of rogue APs removed. The set W is then made equal to P (i.e., W=P). If Q is not empty, then P is the set of all radios that are neighbors of the radios under consideration for a channel change (i.e., P=N {Q (₁)} U N {Q (₂)} U . . . N {Q (_{M})}. All the rogue radios are than removed from the set of all radios (i.e., W=U−S), and then all the radios that are under consideration for possible channel change because of high RSSI value are removed from W (e.g., W=W−Q such that all candidates considered fox possible channel change due to high RSSI are eliminated and the remaining set of radios are stored in W). The neighbors of the candidates for channel changing (P—as found above) are eliminated from W. T is then set equal to the size (e.g., the number of entries) of W, and an iterative loop is started from 1 to T whereby t=1 to T: Step 1−Q=Q+W(t) if the Tx error to Tx success ratio (e.g., Tx error rate) or the Rx error to Rx success ratio (e.g., Rx error rate) of W(t) is below a desired value, and if W(t) is included in Q, then M is incremented (i.e., M=M+1). The neighbors of W(t) are then eliminated from W (i.e., W=W−N{W(t)}) and W(t) is eliminated from W (i.e., W=W−W(t)). The value of T (for the loop iteration) is then updated (i.e., T=T−(number of neighbors of W(t)+1) because W(t) is also being removed from W. Once this iterative process is complete, Q contains the one or more possible candidates for a channel change, where that candidacy may also be based on Tx and/or Rx error rates in addition to high RSSI values. In this example, Q={A}.

A next step in this process may be to remove from the list of identified candidates, Q, any of the previously considered APs, Q_{PREV}. In this example, Q ={A}−{ }, since there were no previous candidates considered for channel change, the set Q remains unchanged.

The process next considers the RSSI bitmaps (FIGS. 6D, 6E, and 6F) and performs the following iterations for each AP in Q: first, a loop is established to execute from 1 to M (e.g., loop start+{m=1 to M}) to find out the best suited channel for Q(m). For the current operating channel of an AP in Q, a channel is chosen that has less combined RSSI effect, provided the combined RSSI effect is less than the RSSI currently being observed in the operating channel. In the present example, A will find both channels 1 and 6. Since only one AP (e.g., B and C) is operating in each of these channels (1 and 6). Now, comparing their combined RSSI effect it can be seen that RSS1₆ =RSSI_{B}+0=65; here 0 is added explicitly to indicate that if there were additional APs operating in this channel, they would have been considered as well. It may also be seen that RSSI₁=RSSI_{C}+0=70 and RSSI₁₁=RSSI_{D}+RSSI_{E}=65+75=140. Since RSSI₆ is less than RSSI₁ and RSSI₁₁, AP A would switch to channel 6 and also the combined RSSI effect in channel 6 is less than the RSSI observed in the current operating channel (i.e., 70 in channel 1), so AP A will switch to channel 6. It may be appreciated that the RSSI values used in the previous calculations are obtained from the operational data structures, after it was found that bit for radio A, at column numbers corresponding to B and C radios are set in RSSI bitmaps B₆ and B₁₁ (FIGS. 6E and 6F).

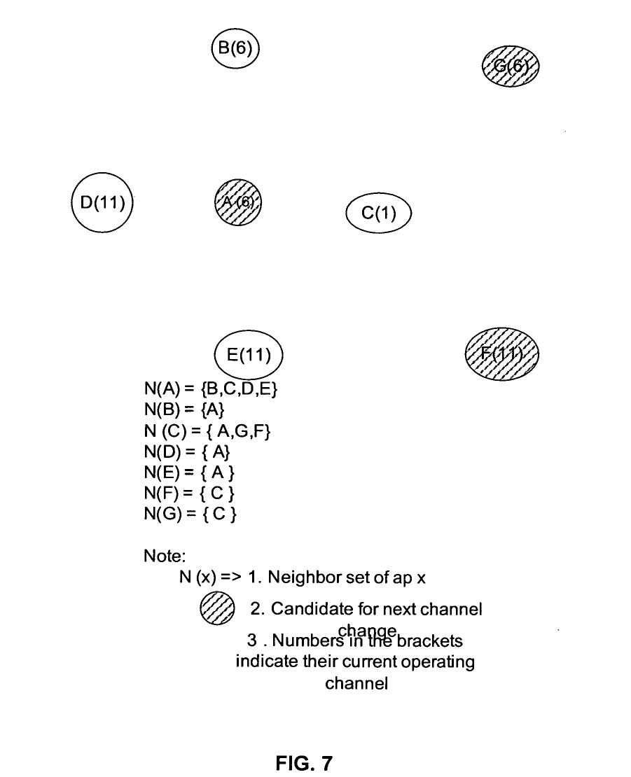

If there is a contention between which channel to choose because the levels are the same, then the channel where less number of APs are found should generally be chosen. If there still is a contention (e.g., same value and same number of APs), then randomly chose any one of the channels in contention. Once a channel is chosen, then the chosen channel is assigned to that AP, the counter is incremented (m=m+1), and the process moves to next element, Q(m+1). Once the process is complete, then Q_{PREV} is updated such that Q_{PREV}=Q_{PREV}+Q; whereby the current candidate list, Q, is added to Q_{PREV}, which should be considered when next time the algorithm is executed. In the current example, Q_{PREV} { }+{A}, so Q_{PREV} {A}. In the example discussed herein, after the channel algorithm the APs with channel assignment would look as shown in FIG. 7 (to be compared with FIG. 5).

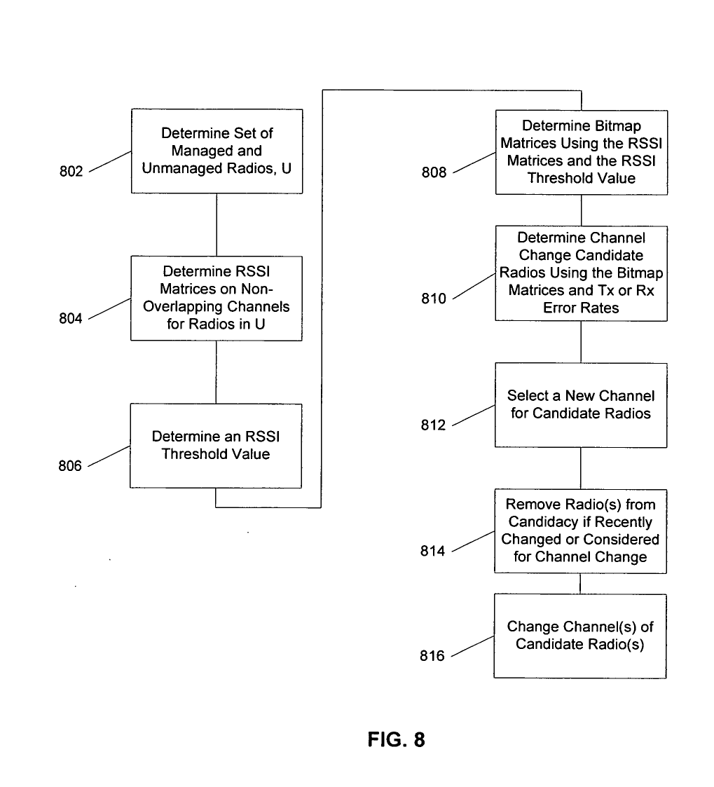

The embodiment of a channel selection algorithm specifically described in the above example can be more generally stated in the flowchart of FIG. 8. At step 802, a set of managed and unmanaged radios (U) is determined for a defined geographical area (e.g., office floor, etc.). At step 804, RSSI matrices are determined for each non-overlapping channel of the radios found in step 802. At step 806, a RSSI threshold is determined. At step 808, bitmap matrices are determined for each of the matrices found in step 806, whereby a bit is set for each RSSI value that exceeds the RSSI threshold. At step 810, a set of radios (Q) are determined that are candidates for having their channels changed whereby the set is determined based on candidates causing an RSSI value that exceeds the RSSI threshold on another radio. Candidates may also be chosen based on acceptable (or unacceptable) Tx and/or Rx error rates. At step 812, the radios found in step 810 have a candidate channel selected for changing their channel based on (a) a 30 channel having the lowest RSSI value, (b) the number of radios already operating on a channel, and (c) random assignment. Before switching a radio's channel, however, at step 814 it is determined whether the radio was a recent candidate for a channel change and, if so, it is removed from consideration in order to avoid frequent and multiple channel changes by the same radio. The process culminates at step 816 where the channels are changed for those radios remaining in the set under consideration.

The above examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention

Throughout this application, various publications and/or standards may be referenced. The disclosures of these publications in their entireties are hereby incorporated by reference into this application in order to more fully describe the state of the art to which this invention pertains.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. A method comprising:
determining a plurality of access points configured to communicate via a wireless network comprising a plurality of channels, including a first channel and a second channel;
selecting an access point of the plurality of access points, the selected access point being configured to operate on the first channel;
determining a first received signal strength indication (RSSI) associated with the first channel and a second RSSI associated with the second channel, wherein the first RSSI is greater than the second RSSI; and
configuring the selected access point to operate on the second channel of the plurality of channels of the wireless network.

13. The method of claim 12 wherein the determining a plurality of access points comprises determining the plurality of access points including one or more managed access points.

14. The method of claim 12 wherein the determining a plurality of access points comprises determining the plurality of access points, wherein each access point includes one or more transceivers configured to operate on one of the plurality of channels.

15. The method of claim 12 wherein the selecting comprises selecting the access point from the plurality of access points wherein the first RSSI value is greater than any other RSSI value.

16. The method of claim 12 wherein the selecting comprises selecting the access point of the plurality of access points based on a determination that the access point is not included in a history of recently configured access points.

17. The method of claim 12 wherein the determining a first RSSI comprises determining a matrix associated with each of the plurality of channels, the matrix comprising an RSSI between each of the plurality of access points configured to operate on each channel.

18. The method of claim 17 wherein the determining a first RSSI comprises determining a bitmap associated with each matrix, the bitmap indicating for each RSSI whether the RSSI is greater than an RSSI threshold.

19. The method of claim 12 wherein the determining a first RSSI comprises receiving from the selected access point the first RSSI and the second RSSI.

20. The method of claim 12 wherein the determining a first RSSI comprises determining the first RSSI, wherein the first RSSI comprises a combined RSSI for each of the plurality of access points causing interference during an operation of the selected access point on the first channel.

21. A system comprising:
a plurality of access points comprising one or more transceivers configured to operate on one of a plurality of channels;
a wireless network including the plurality of channels;
the one or more transceivers of each access point being configured to determine a received signal strength indication (RSSI) for each of the plurality of channels; and
a central controller associated with the wireless network, the central controller being configured to:
determine one or more potential operating channels for each transceiver based on a determination that the RSSI associated with each of the potential operating channels is less than a threshold RSSI, and
configure at least one of the transceivers to operate on one of the potential operating channels associated with the at least one transceiver.

22. The system of claim 21 wherein the plurality of access points comprise one or more transceivers configurable by the central controller.

23. The system of claim 21 wherein each transceiver is configurable to operate on any one of the plurality of channels.

24. The system of claim 21 wherein the plurality of access points are arranged into one or more neighborhoods wherein the central controller is configured to select the at least one transceiver from, at most, one access point per neighborhood.

25. The system of claim 21 wherein the central controller is configured to select a potential operating channel for the at least one transceiver wherein the potential operating channel is associated with an RSSI that is less than an RSSI associated with a channel on which the at least one transceiver is previously configured to operate.

26. The system of claim 21 wherein the at least one transceiver is associated with an RSSI that is greater than any other RSSI associated with any other transceiver.

27. A method comprising:
determining an interference level and a packet error rate associated with each of a plurality of access points arranged into one or more neighborhoods of a wireless network comprising a plurality of channels, wherein each access point is configurable to operate on one of the plurality of channels;
determining a candidate list comprising, at most, one access point from each neighborhood wherein the packet error rate associated with each access point of the candidate list is less than a threshold error rate;
selecting, for each access point of the candidate list, a low interference channel from the plurality of channels wherein the low interference channel is associated with an interference level below a threshold interference value; and
configuring each access point of the candidate list to operate on the low interference channel associated with each of the access points.

28. The method of claim 27 wherein the determining an interference level comprises determining one or more interfering access points of the plurality of access points associated with one or more of the access points based on a received signal strength indication (RSSI) associated with each access point.

29. The method of claim 27 wherein the determining a candidate list comprises determining that each access point of the candidate list is not included in a history list associated with recently configured access points.

30. The method of claim 27 wherein the determining a candidate list comprises:
determining which of the plurality of access points are associated with the highest interference levels; and
determining the candidate list, wherein the candidate list comprises at least the access point with the highest interference level.

31. The method of claim 27 wherein the configuring comprises updating a history list associated with recently configured access points.
